(19) United States
(12) Patent Application Publication
(10) Pub. No.: US 2013/0251962 A1
(43) Pub. Date: Sep. 26, 2013

(54) COLOR CHANGE COMPRESSION FABRICS AND GARMENTS

(71) Applicant: Carolon Company, Rural Hall, NC (US)

(72) Inventor: Lawrence G. Reid, JR., Germanton, NC (US)

(73) Assignee: Carolon Company, Rural Hall, NC (US)

(21) Appl. No.: 13/709,080

(22) Filed: Dec. 10, 2012

Related U.S. Application Data
(60) Provisional application No. 61/630,291, filed on Dec. 8, 2011.

(51) Int. Cl. A61H 1/00; D04B 21/00; D03D 7/00

(52) U.S. Cl. CPC A61H 1/008; D03D 7/00; D04B 21/00
USPC 428/196; 428/221; 442/184; 442/306

(57) ABSTRACT

A color change compression fabric and/or garment can include an elastic material having one color in an unstretched condition that changes to a different color in a stretched condition. The different, stretched color corresponds to a predetermined amount of stretch applied to the material, which in turn can correspond to a predetermined amount of compressive pressure. The compression fabric may include a covering yarn having a first color and wrapped a number of turns about an elastic yarn having a second color different than the first color. When the fabric is stretched, the turns of the covering yarn move apart from each other to expose the second color of the elastic yarn underneath. A particular amount of fabric stretch can provide a unique color profile of a combination of the first and second colors, and the unique color profile preferably corresponds to a certain amount of compressive pressure.

### CROSS-REFERENCE TO RELATED APPLICATION

This application claims benefit of U.S. Provisional Patent App. No. 61/630,291, filed Dec. 8, 2011, which application is incorporated by reference herein in its entirety.

### FIELD OF THE INVENTION

The present invention relates to compression fabric and garments made from elastic materials that change color in relation to the amount of stretch applied to the materials. Such color change compression fabric and garments may be useful for allowing a user to easily determine an amount of compressive pressure applied at different locations on a person's body by the visible color of the fabric at a particular location.

### BACKGROUND OF THE INVENTION

Accurate compression is often required for the treatment or prevention of orthopedic or vascular conditions, as insufficient compression may not provide optimal treatment, or prevention. Excessive compression can retard blood flow, leading to detrimental results. In conventional compression fabrics and garments, the compressive force that a fabric generates when worn is unknown, as there is no means inherent in the fabric to indicate the compressive force being applied.

Compressive force can be generated by both the horizontal force and the longitudinal force provided by a compression garment (such as a compression stocking or sleeve). For example, a garment may apply compression in a horizontal direction. By pulling the stocking or sleeve further up the limb on which it is being worn, the longitudinal force can be increased, thereby increasing the overall compressive force on the limb.

Some conventional compression bandages have indicia knitted into the fabric to indicate an amount of stretch that may be applied. For example, a compression garment can include a rectangle design, such that when the garment is stretched longitudinally to a desired degree, the rectangle forms a square. Such a design can indicate compressive force in only one axis, that is, along its longitudinal stretch. In addition, such indicia do not easily indicate graduations of compression.

The amount of compressive force—either quantitative or qualitative—provided by such conventional fabrics and garments is unknown when applied to a person's body. That is, the amount of compressive force applied to a wearer of a conventional garment cannot be determined by the wearer or by another person assisting the wearer, such as a family caregiver or healthcare professional. In addition, the actual compressive force applied can also depend on the fit of the garment on an anatomical area. In certain instances, it may be desired that the compressive pressure be graduated along an anatomical area, such as a leg. Thus, it is important to know with some accuracy the amount of compressive pressure being applied at various locations along the anatomical area. As a result, accurate application of a particular compressive force desired in certain therapeutic applications may be difficult to achieve using conventional compression garments.

Another disadvantage of conventional compression fabrics and garments is that the initial compressive force of such a garment when applied can often diminish over time as a consequence of yarn fatigue. Yarn fatigue is defined as the weakening of a yarn caused by a loss of some of its ability to recover to its original shape or size after being deformed repeatedly. As a compression garment over time loses elasticity and the ability to provide a particular compressive force, it becomes important to know the amount of compressive pressure the garment can actually provide after repeated and/or prolonged use.

The amount of compression that a fabric or garment is capable of generating can be affected by various yarn and construction factors. Such factors can include, for example, yarn type and size (for example, denier); characteristics of elastic yarns utilized (for example, how an elastic yarn is extruded and/or wrapped, including under how much tension a yarn is wrapped); and fabric structure (such as stitch size and/or density). Since such yarn and fabric construction factors can vary during manufacturing, the amount of compressive pressure can vary in a resulting product.

Thus, there is a need for a means for easily and accurately determining an amount of compressive pressure applied to an anatomical area by a compressive pressure garment. There is a need for such a means for easily and accurately determining an amount of compressive pressure that is integrated into the garment.

### SUMMARY OF THE INVENTION

Some embodiments of the present invention include a compression fabric, comprising an elastic material having one color in an unstretched condition that changes to a different color in a stretched condition. In such embodiments, the different, stretched color corresponds to a predetermined amount of stretch applied to the material. In certain embodiments, the predetermined amount of stretch applied to the material corresponds to a predetermined amount of compressive pressure. The stretched color can comprise a first stretched color corresponding to a first predetermined amount of stretch and a second stretched color corresponding to a second predetermined amount of stretch. The first amount of stretch and the second amount of stretch can each correspond to a different predetermined amount of compressive pressure. The predetermined amount of stretch can be applied to the material in a longitudinal direction, in a horizontal direction, or in a combination of longitudinal and horizontal directions.

In some embodiments, the elastic material can further comprise an elastic yarn covered by a covering yarn wrapped about the elastic yarn. In such embodiments, the covering yarn can further comprise the one color in the unstretched condition and the elastic yarn can further comprise the different, stretched color visible in the stretched condition. Each of different predetermined amounts of applied stretch can provide a unique color profile of a different combination of the one color in the unstretched condition and the different, stretched color. In certain embodiments, each unique color profile corresponds to a different amount of compressive pressure.

The compression fabric can further comprise a compression garment. In some embodiments, the compression fabric can further comprise a graduated compressive pressure garment, in which the different predetermined amounts of compressive pressure are graduated across selected locations in the garment.

Certain embodiments can include a color-compression guide integrated into the fabric and comprising indicia relating the stretched color to the corresponding predetermined amount of stretch and/or a particular compressive pressure. The color-compression guide indicia can remain unchanged when the fabric is stretched.

In an exemplary embodiment, the compression fabric comprises a covering yarn comprising a covering yarn color and wrapped a number of turns about an elastic yarn comprising an elastic yarn color different than the covering yarn color. When the fabric is stretched a first amount, the turns of the covering yarn move apart from each other to expose a first amount of the elastic yarn color corresponding to a first predetermined amount of compressive pressure. Likewise, when the fabric is stretched a second amount, the turns of the covering yarn move apart from each other to expose a second amount of the elastic yarn color corresponding to a second predetermined amount of compressive pressure. That is, each of different amounts of fabric stretch can provide a unique color profile of a different combination of the covering yarn color and the elastic yarn color. Each unique color profile can correspond to a different amount of compressive pressure.

In one embodiment, the compression fabric can comprise an elastic yarn comprising a first color woven in a warp direction and a filling yarn comprising a second color different than the first color. In another embodiment, the compression fabric can comprise an elastic yarn comprising a first color circularly knit in selected courses and a different base yarn comprising a second color different than the first color circularly knit in other courses. In another embodiment, the compression fabric can comprise an elastic yarn comprising a first color warp knit in a warp direction and a different base yarn comprising a second color different than the first color knit in a weft direction. In yet another embodiment, the compression fabric can comprise an inner layer comprising a first color and an outer layer comprising a second color different than the first color. In still another embodiment, the compression fabric can comprise an inner yarn surface comprising a first color and an outer yarn surface dyed a second color different than the first color. In each of such embodiments, a particular amount of fabric stretch can provide a unique color profile of a combination of the first and second colors, and the unique color profile preferably corresponds to a certain amount of compressive pressure.

Features of a color change compression fabric, garment, and/or method of the present invention may be accomplished singularly, or in combination, in one or more of the embodiments of the present invention. As will be realized by those of skill in the art, many different embodiments of a fabric, garment, and/or method according to the present invention are possible. Additional uses, advantages, and features of the invention are set forth in the illustrative embodiments discussed in the detailed description herein and will become more apparent to those skilled in the art upon examination of the following.

### BRIEF DESCRIPTION OF THE DRAWINGS

FIG. 1 is a diagrammatic view of an elastic yarn having one color and covered by a covering yarn having a different color in an embodiment of the present invention.

FIG. 2 is view of a color change compression fabric/garment in another embodiment of the present invention.

### DETAILED DESCRIPTION

For the purposes of this description, unless otherwise indicated, all numbers expressing quantities, conditions, and so forth used in the description are to be understood as being modified in all instances by the term “about.” Accordingly, unless indicated to the contrary, the numerical parameters set forth in the following description are approximations that can vary depending upon the desired properties sought to be obtained by the embodiments described herein. At the very least, and not as an attempt to limit the application of the doctrine of equivalents to the scope of the invention, each numerical parameter should at least be construed in light of the number of reported significant digits and by applying ordinary rounding techniques.

Notwithstanding that the numerical ranges and parameters setting forth the broad scope of the described embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, for example, 5.5 to 10.

As used in this description, the singular forms “a,” “an,” and “the” include plural referents unless the context clearly dictates otherwise. Thus, for example, the term “a yarn” is intended to mean a single yarn or more than one yarn. For the purposes of this specification, terms such as “forward,” “rearward,” “front,” “back,” “right,” “left,” “upwardly,” “downwardly,” and the like are words of convenience and are not to be construed as limiting terms. Additionally, any reference referred to as being “incorporated herein” is to be understood as being incorporated in its entirety.

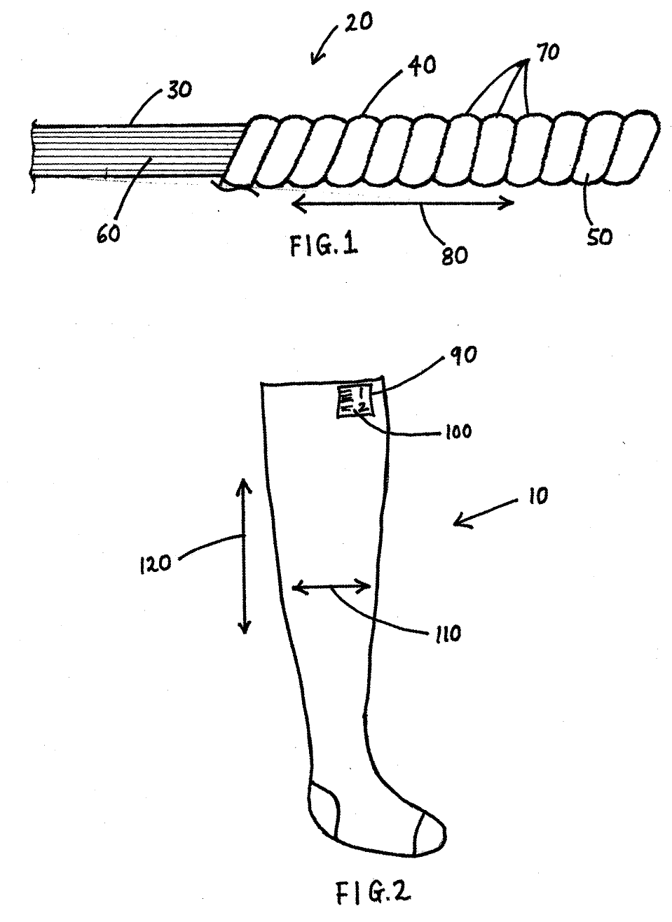

The present invention includes embodiments of a compression fabric and/or garments, and methods of making and/or using such a compression fabric and/or garments. FIGS. 1-2 illustrate such embodiments. Some embodiments include a compression fabric 10 comprising an elastic material 20 having one color in an unstretched condition that changes to a different color in a stretched condition. In such embodiments, the different, stretched color corresponds to a predetermined amount of stretch applied to the material. In certain embodiments, the predetermined amount of stretch applied to the material corresponds to a predetermined amount of compressive pressure. The stretched color can comprise a first stretched color corresponding to a first predetermined amount of stretch and a second stretched color corresponding to a second predetermined amount of stretch. The first amount of stretch and the second amount of stretch can each correspond to a different predetermined amount of compressive pressure. Some embodiments of such a fabric, garment, and/or method may be useful for allowing a user to easily and accurately determine the amount of compressive pressure applied at different locations on a person's body by the visible color of the fabric at a particular location.

The “color” of a stretched fabric and/or garment refers to the predominantly visible color of the fabric and/or garment when it is stretched. The color of a stretched fabric and/or garment can be only the color of a covered yarn that is uncovered, or the color can be a “shade” or combination of the colors of a covering yarn and a yarn uncovered, or otherwise revealed, by stretching. In some embodiments, a particular color may be produced by stretching the fabric and/or garment by a particular amount.

As shown in FIG. 1, the elastic material 20 can be an elastic yarn, or stretch yarn, which can comprise a primary elastic yarn 30 such as spandex or rubber, and a covering yarn 40 such as nylon or polyester. The covering yarn (or “covering”) 40 can comprise a single yarn (as shown in FIG. 1) or two yarns in an “S” and “Z” twist formation. The covering yarn(s) 40 can be wrapped about the primary elastic yarn 30 for a number of turns 70 of the covering yarn(s) 40 per inch of the primary elastic yarn 30. When stretched (as designated by directional arrow 80), the turns 70 of the covering yarn(s) 40 can move apart from each other, exposing the primary elastic yarn 30 underneath. Preferably, the primary elastic yarn 30 is wrapped so as to have a “minimal” wrap covering such that the primary elastic yarn 30 is covered with a minimum number of wraps to cover the primary elastic yarn 30 when unstretched. The number of wraps can be varied depending on the denier and yarn filament count of both the primary yarn 30 and covering yarn(s) 40. As a result, when stretched, the primary elastic yarn 30 can show through the covering yarn(s) 40. Such revealing of an underlying yarn can be referred to as “grin through.”

In some embodiments, the compression fabric, garment 10, and/or method can include the covering yarn 40 having a first color 50 and the primary elastic yarn 30 having a second, different color 60. In a relaxed, or unstretched, condition, the color 50 of the covering yarn 40 is visible, or predominant. As the yarn 20 is stretched (80), the covering yarn 40 moves apart from itself. That is, as the yarn 20 is stretched (80), adjacent turns 70 of the wrapped covering yarn 40 move away from each other. As a result, the color 60 of the primary elastic yarn 30 underneath the covering yarn 40 is exposed, thereby altering the visible, or predominant, color of the yarn 20 (and fabric 10). In this way, a particular compressive pressure related to stretching the compression fabric or garment 10 can be associated with a change in color of the yarn 20 and fabric 10.

For example, as shown in FIG. 1, the covering yarn 40 can have the white color 50 and the primary elastic yarn 30 can have the blue color 60. In a relaxed, or unstretched, state, or condition, only the white color 50 of the covering yarn 40 is visible. Thus, when unstretched, the compression fabric/garment 10 comprising the covered yarn 40 appears to be white. When the yarn 20 and fabric 10 are stretched (80) and adjacent turns 70 of the covering yarn 40 move apart from each other, the blue color 60 of the primary elastic yarn 30 underneath the covering yarn 40 is exposed. As a result, the predominantly visible color of the yarn 20/fabric 10 becomes blue. Accordingly, appearance of the blue color 60 indicates a particular compressive pressure related to an amount of stretching the compression fabric/garment 10.

In alternative embodiments, the color of the elastic yarn 60 and the covering yarn 50 vary. In one alternative embodiment (not shown), the covering yarn 40 can have a blue color and the primary elastic yarn 30 can have a white color. In a relaxed, or unstretched, state, only the blue color of the covering yarn 40 is visible. Thus, when unstretched, the compression fabric/garment 10 comprising the covered yarn 40 appears to be blue. When the yarn 20 and fabric 10 are stretched (80) and adjacent turns 70 of the covering yarn 40 move apart from each other, the white color of the primary elastic yarn 30 underneath the covering yarn 40 is exposed. As a result, the predominantly visible color of the yarn 20/fabric 10 becomes white. Thus, appearance of the white color indicates a particular compressive pressure related to an amount of stretching the compression fabric/garment 10.

Each of different predetermined amounts of stretch applied to the fabric and/or garment 10 can provide a unique color profile of a different combination of the fabric color in the unstretched condition and the different color in a stretched condition. That is, the more the yarn 20/fabric 10 is stretched (80), the greater the amount of the color of the primary elastic yarn 30 becomes visible, resulting in the fabric 10 taking on the appearance of relatively more of the color 60 of the underlying primary elastic yarn 30. For example, when the primary elastic yarn 30 has the blue color 60, stretching (80) the compression fabric/garment 10 comprising the primary elastic yarn 30 a first amount results in the appearance of a first shade (for example, a light shade) of blue 60. Stretching (80) the fabric/garment 10 a further, second amount, results in the appearance of a second shade (for example, a medium shade) of blue 60. Stretching the fabric/garment 10 an even further, third amount, results in the appearance of a third shade (for example, a darker shade) of blue 60. Accordingly, each unique color profile corresponds to a different amount of compressive pressure.

Each of the shades of the primary elastic yarn color 60 appearing upon a particular amount of stretching (80) can be associated with a certain compressive pressure. For example, in the compressive pressure stocking 10, the first amount of stretching that results in a light shade of blue 60 may create a compressive pressure at an area on a leg in the range of about 30-40 mm Hg. The second amount of stretching that results in a medium shade of blue 60 may create a compressive pressure at an area on a leg in the range of about 40-50 mm Hg. The third amount of stretching that results in a darker shade of blue 60 may create a compressive pressure at an area on a leg in the range of about 50-60 mm Hg. Thus, stretching the fabric/garment 10 a particular amount can result in a certain, or unique, color profile that represents a pre-determined amount of compressive pressure.

The amount of compressive pressure that corresponds to a particular amount of stretch, and thus to a unique color profile, can be predetermined through manufacturing specifications for a particular compressive pressure product.

In certain embodiments, the color change fabric and/or garment 10 can further include different color changes upon stretching a certain amount at particular locations in the fabric/garment 10. For example, a graduated compression garment can provide a first compressive pressure at a first anatomical location, such as in a foot, a second compressive pressure at a second anatomical location, such as at an ankle, and a third compressive pressure at a third anatomical location, such as in the calf of a leg. Upon a certain amount of stretching, the color change fabric and/or garment 10 can provide a first color profile at the first location (foot) when the first compressive pressure is reached, a second color profile at the second location (ankle) when the second compressive pressure is reached, and a third color profile at the third location (calf) when the third compressive pressure is reached. In this way, different compressive pressures along the fabric/garment 10 are represented by the different colors. In such a color change compression fabric and/or garment 10, different colors, or shades of color, at various locations can indicate a graduation in compressive pressure across those locations.

The amount of color change related to an amount of stretching the yarn 20/fabric 10 can be adjusted by varying the number of turns 70 of the covering yarn(s) 40 per inch of the underlying primary elastic yarn 30. For example, a smaller number of turns 70 of the covering yarn(s) 40 per inch of the primary elastic yarn 30 can provide a larger degree of exposure of the primary elastic yarn color 60 when the yarn 20 is stretched (80). Likewise, a larger number of turns 70 of the covering yarn(s) 40 per inch of the primary elastic yarn 30 can provide a smaller degree of exposure of the primary elastic yarn color 60 when the yarn 20 is stretched (80).

In some embodiments of the color change compression fabric and/or garment 10, the covering yarn 40 can have a first color 50 and the primary elastic yarn 30 can have a second color 60 different than the first color 50. The different colors 60, 50 of the elastic yarn 30 and of the covering yarn 40 can vary to provide a desired color profile when the yarns 20 are stretched (80) a certain amount, thereby representing a particular level of compression. As an example, the covering yarn 40 may have a blue color and the elastic yarn 30 may have a yellow color, such that when the fabric 10 comprising the covered elastic yarn 20 is stretched (80) a certain amount for a particular compressive pressure, the predominant visible color of the fabric 10 is green. That is, as adjacent turns 70 of the blue covering yarn(s) 40 move apart from each other when stretched (80) to reveal some of the yellow of the elastic yarn 30 underneath, the combined color profile can be green. Embodiments of the color change compression fabric and/or garment 10 of the present invention can include any combination of colors to provide a desired color profile when stretched a particular amount.

In some embodiments, all of the yarns in the fabric 10 can be colored to achieve a particular color change upon a certain amount of stretching. In other embodiments, only a selected portion of the yarns in the fabric 10 are colored to achieve a particular color change upon a certain amount of stretching.

Certain embodiments of the color change fabric/garment 10 can further include a color-compression guide 90, or key, as shown in FIG. 2. For example, at a desired location on the color change garment 10, the garment 10 can indicate the color to which at least a portion of the garment 10 will change when the garment 10 is stretched to provide a particular compressive pressure. In this way, a user can readily determine when the fabric/garment 10 has been stretched sufficiently to provide the desired compressive pressure. In some embodiments, the color-compression guide 90 can further include indicia 100 of the amount (for example, 30-40 mm Hg) of compressive pressure associated with a particular color. In some embodiments, the color-compression guide 90 can further include indicia 100 of colors representing desired graduated compressive pressures at particular locations to which the fabric/garment 10 is applied. For example, the guide 90 may include a light blue color desired in a foot area, a medium blue color in an ankle area, and a darker blue color in a calf area, to indicate desired graduated pressures in those respective areas.

In some embodiments, the color-compression guide 90 can be printed onto the fabric/garment 10. Alternatively, the yarns comprised in the color-compression guide 90 can be non-elastic yarns so that any stretching of the garment will not affect the color(s) in the color-compression guide 10. That is, when the guide 90 is stretched, the color representing a particular compressive force will remain constant, or unchanged. For example, in an embodiment in which the color for 30-40 mm Hg of compressive pressure is a medium green, when the guide 90 is stretched, the yarns in the color-compression guide 90 representing the color for 30-40 mm Hg of compressive pressure will remain medium green.

In addition, or alternatively, the color-compression guide 90 may be provided on packaging or on a product insert for reference by a user.

The construction of the fabric 10 can also affect the amount of color change and in what axis the color would appear. For example, the compression hosiery product 10 generally has two-way stretch; that is, stretching occurs along both a horizontal, or latitudinal, axis 110, and along a vertical, or longitudinal axis 120. Thus, stretching a compressive pressure garment, such as the compressive pressure hosiery product 10, can cause color to change in both horizontal 110 and longitudinal 120 directions.

Embodiments of the color change compression fabric and/or garment 10 according to the present invention can be fabricated using various methods. For example, the color change compression fabric and/or garment 10 can be woven utilizing narrow needle looms. In such an embodiment, the primary elastic yarn 30, such as spandex, can be used in the warp, or longitudinal, direction. The filling, or latitudinal, yarn can comprise any fiber base, such as nylon, polyester, cotton, etc. The primary elastic yarn 30 can comprise a first color 60, and the filling yarn can comprise a second, different color 50.

The more the woven fabric or garment 10 is stretched, the greater the amount of the color 60 of the primary elastic yarn 30 becomes visible, resulting in the fabric 10 taking on the appearance of relatively more of the color 60 of the primary elastic yarn 30. For example, when the compression fabric/garment 10 comprises the primary elastic yarn 30 having the blue color 60, stretching the fabric/garment 10 a first amount results in the appearance of a first shade (for example, a light shade) of blue 60. Stretching the fabric/garment 10 a further, second amount, results in the appearance of a second shade (for example, a medium shade) of blue 60. Stretching the fabric/garment 10 an even further, third amount, results in the appearance of a third shade (for example, a darker shade) of blue 60. Each of the shades of the woven primary elastic yarn color 60 appearing upon a particular amount of stretching can be associated with a certain amount of compressive pressure.

In another embodiment, the color change compression fabric and/or garment 10 can be knit utilizing a circular knitting machine. In such an embodiment, the primary elastic yarn 30 can be introduced into the fabric 10 by a knitted-in method or a laid-in method. For the knitted-in method, the color change primary elastic yarn 30 can be fed in alternating courses with yarns of any other base yarn such as nylon, polyester, cotton, etc. For the laid-in method, the color change primary elastic yarn 30 can be “laid in” any suitable knitted fabric. The primary elastic yarn 30 can comprise the first color 60, and the base yarn can comprise a second, different color.

The more the knitted fabric or garment 10 is stretched, the greater the amount of the color 60 of the primary elastic yarn 30 becomes visible, resulting in the fabric 10 taking on the appearance of relatively more of the color 60 of the primary elastic yarn 30. For example, when the compression fabric/garment 10 comprises the primary elastic yarn 30 having the blue color 60, stretching the fabric/garment 10 a first amount results in the appearance of a first shade (for example, a light shade) of blue 60. Stretching the fabric/garment 10 a further, second amount, results in the appearance of a second shade (for example, a medium shade) of blue 60. Stretching the fabric/garment 10 an even further, third amount, results in the appearance of a third shade (for example, a darker shade) of blue 60. Each of the shades of the primary elastic yarn color 60 in the knitted fabric/garment 10 appearing upon a particular amount of stretching can be associated with a certain amount of compressive pressure.

In another embodiment, the color change compression fabric and/or garment 10 can be made utilizing a warp knitting machine. In such an embodiment, the primary elastic yarn 30 can be knit in the warp or longitudinal direction of the fabric 10. Yarns used for the weft, or latitudinal, direction can comprise any desired yarn. The primary elastic yarn 30 can comprise the first color 60, and the weft yarn can comprise a second, different color.

The more the warp knitted fabric or garment 10 is stretched, the greater the amount of the color 60 of the primary elastic yarn 30 becomes visible, resulting in the fabric 10 taking on the appearance of relatively more of the color 60 of the primary elastic yarn 30. For example, when the compression fabric/garment 10 comprises the primary elastic yarn 30 having the blue color 60, stretching the fabric/garment 10 a first amount results in the appearance of a first shade (for example, a light shade) of blue 60. Stretching the fabric/garment 10 a further, second amount, results in the appearance of a second shade (for example, a medium shade) of blue 60. Stretching the fabric/garment 10 an even further, third amount, results in the appearance of a third shade (for example, a darker shade) of blue 60. Each of the shades of the primary elastic yarn color 60 in the warp knitted fabric/garment 10 appearing upon a particular amount of stretching can be associated with a certain amount of compressive pressure.

In another embodiment, the color change compression fabric and/or garment 10 can comprise multiple layers of fabric (not shown). The at least two fabric layers may or may not be intertwined. An inner layer can comprise a first color and an outer layer can comprise a second, different color. When the multi-layer fabric/garment 10 is stretched, the color of the inner layer becomes visible through the outer layer. The more tension, or stretch, that is applied to the fabric/garment 10, the more the color of the fabric 10 would appear to be that of the inner layer. In embodiments comprising two or more layers of fabric, the primary elastic yarn 30 may or may not be used, depending on the desired effect. Each shade of the inner layer color appearing upon a particular amount of stretching can be associated with a certain amount of compressive pressure.

In another embodiment, the color change compression fabric and/or garment 10 can be made utilizing surface dyeing. The surface of the fabric 10 can be dyed using a padding process, in which a light layer of dye of a different color is applied to the surface of a full width fabric. Surface dyeing can also be achieved in a batch dyeing process by limiting the dye cycle time to keep the dye from fully penetrating the fabric surface. In both instances, the interior of the fabric 10 remains a different color than the surface of the fabric. When the surface-dyed fabric 10 is stretched, more of the interior color shows through the fabric to create a color change representative of a different compressive pressure than the original pressure. Each shade of the interior color appearing upon a particular amount of stretching can be associated with a certain amount of compressive pressure.

Various embodiments of the color change compression fabric and/or garment 10 can be utilized effectively in combination with other therapeutic and/or cosmetic garments. For example, an embodiment of the color change compression fabric and/or garment 10 can be utilized with an underlying compression garment. Such an underlying, first layer compression garment may provide “mild” compression. Such a first layer compression garment may include padding such as an inner terry surface. An embodiment of the color change compression fabric and/or garment 10 can be utilized with consumer garments, including, for example, compression running socks and/or arm sleeves.

Although the present invention has been described with reference to particular embodiments, it should be recognized that these embodiments are merely illustrative of the principles of the present invention. Those of ordinary skill in the art will appreciate that a color change compression fabric, garment, and/or methods of the present invention may be constructed and implemented in other ways and embodiments. Accordingly, the description herein should not be read as limiting the present invention, as other embodiments also fall within the scope of the present invention.

What is claimed is:

1. A compression fabric, comprising:
an elastic material having one color in an unstretched condition that changes to a different color in a stretched condition,
wherein the different, stretched color corresponds to a predetermined amount of stretch applied to the material.

2. The compression fabric of claim 1, wherein the predetermined amount of stretch applied to the material corresponds to a predetermined amount of compressive pressure.

3. The compression fabric of claim 1, wherein the stretched color further comprises (a) a first stretched color corresponding to a first predetermined amount of stretch and (b) a second stretched color corresponding to a second predetermined amount of stretch.

4. The compression fabric of claim 3, wherein the first amount of stretch and the second amount of stretch each corresponds to a different predetermined amount of compressive pressure.

5. The compression fabric of claim 1, the elastic material further comprising an elastic yarn covered by a covering yarn wrapped about the elastic yarn,
wherein the covering yarn further comprises the one color in the unstretched condition and the elastic yarn further comprises the different, stretched color visible in the stretched condition.

6. The compression fabric of claim 1, wherein each of different predetermined amounts of applied stretch provides a unique color profile of a different combination of the one color in the unstretched condition and the different, stretched color.

7. The compression fabric of claim 6, wherein each unique color profile corresponds to a different amount of compressive pressure.

8. The compression fabric of claim 1, further comprising a compression garment.

9. The compression fabric of claim 4, further comprising a graduated compressive pressure garment, wherein the different predetermined amounts of compressive pressure are graduated across selected locations in the garment.

10. The compression fabric of claim 1, further comprising a color-compression guide integrated into the fabric and comprising indicia relating the stretched color to at least one of the group of the corresponding predetermined amount of stretch and a particular compressive pressure.

11. The compression fabric of claim 10, wherein the color-compression guide indicia remain unchanged when the fabric is stretched.

12. The compression fabric of claim 1, wherein the predetermined amount of stretch is applied to the material in a longitudinal direction, in a horizontal direction, or in a combination of longitudinal and horizontal directions.

13. A compression fabric, comprising:
a covering yarn comprising a covering yarn color and wrapped a number of turns about an elastic yarn comprising an elastic yarn color different than the covering yarn color,
wherein when the fabric is stretched a first amount, the turns of the covering yarn move apart from each other to expose a first amount of the elastic yarn color corresponding to a first predetermined amount of compressive pressure, and
wherein when the fabric is stretched a second amount, the turns of the covering yarn move apart from each other to expose a second amount of the elastic yarn color corresponding to a second predetermined amount of compressive pressure.

14. The compression fabric of claim 13,
wherein each of different amounts of fabric stretch provides a unique color profile of a different combination of the covering yarn color and the elastic yarn color, and
wherein each unique color profile corresponds to a different amount of compressive pressure.

15. A compression fabric, comprising:
an elastic yarn comprising a first color woven in a warp direction; and
a filling yarn comprising a second color different than the first color,
wherein a particular amount of fabric stretch provides a unique color profile of a combination of the first and second colors, and wherein the unique color profile corresponds to a certain amount of compressive pressure.

16. A compression fabric, comprising:
an elastic yarn comprising a first color circularly knit in selected courses; and
a different base yarn comprising a second color different than the first color circularly knit in other courses,
wherein a particular amount of fabric stretch provides a unique color profile of a combination of the first and second colors, and wherein the unique color profile corresponds to a certain amount of compressive pressure.

17. A compression fabric, comprising:
an elastic yarn comprising a first color warp knit in a warp direction; and
a different base yarn comprising a second color different than the first color knit in a weft direction,
wherein a particular amount of fabric stretch provides a unique color profile of a combination of the first and second colors, and wherein the unique color profile corresponds to a certain amount of compressive pressure.

18. A compression fabric, comprising:
an inner layer comprising a first color; and
an outer layer comprising a second color different than the first color,
wherein a particular amount of fabric stretch provides a unique color profile of a combination of the first and second colors, and wherein the unique color profile corresponds to a certain amount of compressive pressure.

19. A compression fabric, comprising:
an inner yarn surface comprising a first color; and
an outer yarn surface dyed a second color different than the first color,
wherein a particular amount of fabric stretch provides a unique color profile of a combination of the first and second colors, and wherein the unique color profile corresponds to a certain amount of compressive pressure.
